(19) United States
(12) Patent Application Publication
(10) Pub. No.: US 2018/0144062 A1
(43) Pub. Date: May 24, 2018

(54) COMPUTER DEVICE AND METHOD FOR FACILITATING USER TO MANAGE CONTAINERS

(71) Applicant: Institute For Information Industry, Taipei (TW)

(72) Inventor: Kai-Yuan JAN, Taipei City (TW)

(21) Appl. No.: 15/364,194

(22) Filed: Nov. 29, 2016

(30) Foreign Application Priority Data
Nov. 21, 2016 (TW) 105138081

(51) Int. Cl. G06F 17/30

(52) U.S. Cl. CPC G06F 17/30958; G06F 17/30339

(57) ABSTRACT

The disclosure is related to a computer device and a method for facilitating a user to manage containers. The method includes: transforming container data including identification data and dependency data into graph data by a computer device; storing the graph data into a graph database by the computer device; and enquiring the graph data in the graph database by the computer device in response to a user input which is based on a graph manipulation language corresponding to the graph database so that the user manages the containers.

### PRIORITY

This application claims priority to Taiwan Patent Application No. 105138081 filed on Nov. 21, 2016, which is hereby incorporated by reference in its entirety.

### FIELD

The present invention relates to a computer device and a method. More specifically, the present invention relates to a computer device and a method for facilitating a user to manage containers.

### BACKGROUND

Linux Container (LXC) is a kind of operating system-level virtualization technology which can pack the application software system into a software container (or simply called “container”), and the container contains program codes of the application software itself as well as necessary operating system kernels and function libraries. Docker is an open source code software project which allows a job deployed in the container by an application to be automatically executed, and this provides an additional software abstraction layer on the Linux operating system and also provides an automatic management mechanism for operating system-level virtualization.

Docker adopts an Advanced UnionFS (AUFS) file system to design container images that can be stacked layer by layer, packs all programs (including applications, related function libraries, and profiles) in the container into a Docker image, and provides a profile named Dockerfile to record each step (including parameters) of the process of creating the container. Then in any environment that supports the Docker platform, a totally identical container can be created from the image to execute the same application. This means that the application together with the program execution environment can be immigrated via the Docker image or even via only the Dockerfile to any environment that supports the Docker platform.

Because the Docker architecture makes it easier to deploy and immigrate containers, the number of containers has experienced a fast increase. However, deployment of the fast increasing number of containers makes it difficult for users to manage the containers, especially various dependency status of the containers (e.g., dependency status between containers, dependency status between containers and physical machines, dependency status between containers and virtual machines, and etc.). Accordingly, in view of deployment of the fast increasing number of containers, providing a scheme that facilitates management of containers and especially various dependency status of containers has become an important objective in the art.

### SUMMARY

The disclosure includes a computer device for facilitating a user to manage containers. The computer device may comprise a processor and a storage. The processor may be configured to transform container data including identification data and dependency data into graph data. The storage may comprise a graph database configured to store the graph data. The processor may be further configured to enquire the graph data in the graph database in response to a user input so that the user manages the containers according to the graph data, wherein the user input is based on a graph manipulation language corresponding to the graph database.

The disclosure includes a method for facilitating a user to manage containers. The method may comprise the following steps of:

transforming container data including identification data and dependency data into graph data by a computer device;

storing the graph data into a graph database by the computer device; and

enquiring the graph data in the graph database by the computer device in response to a user input so that the user manages the containers according to the graph data, wherein the user input is based on a graph manipulation language corresponding to the graph database.

The present invention can transform container data into graph data and store the graph data into a graph database to allow the user to manage the container according to the graph data stored in the graph database. As compared with representations (e.g., texts or tables) of the container data itself that cannot present various dependency status of containers easily, the graph data allows for presenting various dependency status of containers easily and visually through a graph traversal operation. Additionally, transforming the container data into the graph data allows the user to easily enquire the graph data by simply using a graph manipulation language corresponding to the graph database. As can be seen, the present invention surely provides a scheme for managing containers easily under the tendency of a fast increasing number of containers.

What described above presents a summary of the present invention (including the problem to be solved, the means to solve the problem and the effect of the present invention) to provide a basic understanding of the present invention. However, this is not intended to encompass all aspects of the present invention. Additionally, what described above is neither intended to identify key or essential elements of the present invention, nor intended to define the scope of the present invention. This summary is provided only to present some concepts of a part of aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a computer device for facilitating a user to manage containers according to one or more embodiments of the present invention.

FIG. 2 illustrates a process of transforming container data into graph data according to one or more embodiments of the present invention.

FIG. 3 illustrates a format of a graph database according to one or more embodiments of the present invention.

FIG. 4 illustrates a container environment according to one or more embodiments of the present invention.

FIG. 5 illustrates graph data in a graph database according to one or more embodiments of the present invention.

FIG. 6 illustrates a method for facilitating a user to manage containers according to one or more embodiments of the present invention.

### DETAILED DESCRIPTION

The example embodiments described hereinafter are not intended to limit the present invention to any specific examples, embodiments, environment, applications, structures, processes or steps described in these example embodiments. In the attached drawings, elements unrelated to the present invention are omitted from depiction. In the attached drawings, dimensions of individual elements and dimensional scales among the individual elements are illustrated only as examples, but not to limit the present invention. Unless otherwise stated, like (or similar) reference numerals correspond to like (or similar) elements in the following descriptions.

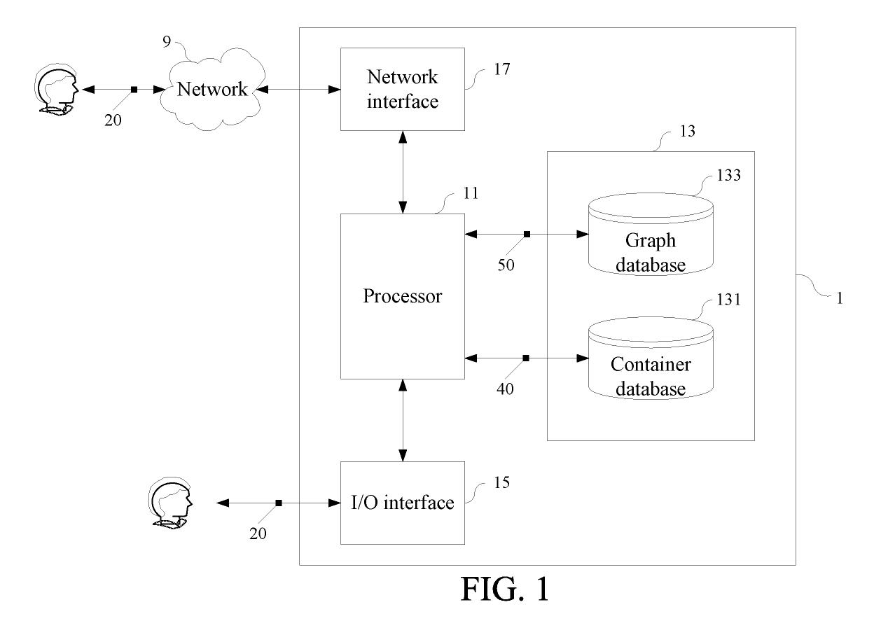

FIG. 1 illustrates a computer device for facilitating a user to manage containers according to one or more embodiments of the present invention. However, the computer device illustrated in FIG. 1 is only provided as an exemplary example, but not to limit the present invention. Referring to FIG. 1, the computer device 1 may comprise a processor 11, a storage 13, an I/O interface 15 and a network interface 17. The processor 11, the storage 13, the I/O interface 15 and the network interface 17 may be electrically connected with each other via other components (e.g., via various kinds of buses) (i.e., indirectly electrically connected with each other), or may be electrically connected with each other without any other components therebetween (i.e., directly electrically connected with each other). Through the direct connection or the indirect connection, signal transmission and data exchange can be accomplished between the processor 11, the storage 13, the I/O interface 15 and the network interface 17. The computer device 1 may be any of various kinds of computer devices, for example but not limited to a mobile phone, a notebook computer, a tablet computer, a desktop computer or the like.

The processor 11 may be a central processing unit (CPU) of a common computer device/computer, and may be programmed to interpret computer instructions, process data in computer software, and execute various operation procedures. The CPU may be a processor comprised of multiple independent units, or a microprocessor comprised of one or more integrated circuits (ICs).

The storage 13 may comprise any of various storage units of common computer devices/computers. The storage 13 may comprise a first-level memory (a.k.a. a primary memory or an internal memory), which is usually simply called a memory, directly communicating with the CPU. The CPU can read instruction sets stored in the memory and execute theses instruction sets if necessary. The storage 13 may also comprise a second-level memory (a.k.a. an auxiliary memory or an external memory), which communicates with the CPU not directly but through an I/O channel of the memory and transmits data to the first-level memory via a data buffer. Data stored in the second-level memory will not be lost when the power is turned off (i.e., being non-volatile). The second-level memory may be, e.g., any of various kinds of hard disks, compact disks (CDs) and so on. The storage 13 may also comprise a third-level storage device, i.e., a storage device that can be directly plugged into or removed from the computer (e.g., a mobile disk).

The I/O interface 15 may comprise various input/output elements of a common computer device/computer for receiving data from and transmitting data to the outside, for example but not limited to, a mouse, a trackball, a touch panel, a keyboard, a scanner, a microphone, a user interface (UI), a screen, a touch screen, a projector and so on.

The network interface 17 may comprise at least one physical network interface card of a common computer device/a computer for use as an interconnection point between the computer device 1 and a network 9. The network 9 may be a private network (e.g., a local area network (LAN)) or a public network (e.g., the Internet). The network interface 17 allows the computer device 1 to communicate with and exchange data with other electronic devices on the network 9 either in a wired way or wirelessly depending on different needs. In some embodiments, there may also be a switching device, a routing device or the like between the network interface 17 and the network 9.

Referring to FIG. 1, the processor 11 may be configured to transform container data 40 including identification data and dependency data into graph data 50. The identification data may comprise identification data of a container and identification data of at least one of a physical machine and a virtual machine. The identification data of the container may include but is not limited to, a container name, a container identification code, a process identification code, an image identification code, an execution status of the container, a CPU usage rate, a memory usage amount, an IP address, a communication port, etc. The identification data of the physical machine and the virtual machine may include but is not limited to: a machine name, a CPU usage rate, a memory usage amount, an IP address, a communication port, etc. The dependency data may include at least one of dependency status between containers, dependency status between containers and physical machines, and dependency status between containers and virtual machines.

The storage 13 may comprise a graph database 133 configured to store the graph database 50. In some embodiments, the storage 13 may comprise a container database 131 configured to store the container data 40, and the processor 11 may obtain the container data 40 from the container database 131. In some embodiments, the storage 13 may not comprise the container database 131, and the processor 11 may obtain the container data 40 from outside the computer device 1 via the I/O interface 15 and/or the network interface 17.

After the graph data 50 is stored into the graph database 133, the processor 11 may enquire the graph data 50 in the graph database 133 in response to a user input 20 from a user so that the user can manage the container according to the graph data 50. Here, the user input 20 is based on a graph manipulation language corresponding to the graph database 133. In some embodiments, the processor 11 may receive the user input 20 from the user via the network interface 17 and the network 9. In some embodiments, the processor 11 may receive the user input 20 from the user via the I/O interface 15.

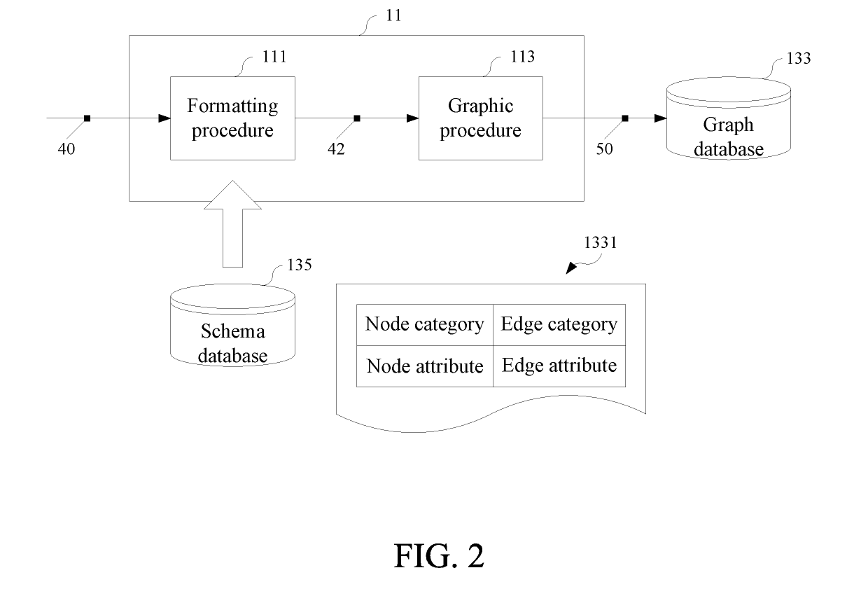

FIG. 2 illustrates a process of transforming container data into graph data according to one or more embodiments of the present invention. However, the process illustrated in FIG. 2 is only provided as an exemplary example but not to limit the present invention. Referring to FIG. 2, the processor 11 may execute a formatting procedure 111 to format the container data 40 into a format 1331 corresponding to the graph database 133, and then execute a graphic procedure 113 to transform the formatted container data 42 into the graph data 50. Assuming that the graph database 133 is a graph database named neo4j, the graphic procedure 113 may transform the formatted container data 42 into graph data based on a graph manipulation language named Cypher to create or update the graph data 50. As an example, the graphic procedure 113 may create a physical machine node named H1, a container node named C1, and an execution edge representing execution of the container node by the physical machine node:
create (host: Crew {name: ‘H1’ }),
(container: Crew {name: ‘V1’}),
(host)-[:run]->(container)

As another example, the graphic procedure 113 may update the CPU usage rate of the container according to the following instructions:
update (container: Crew {name: ‘V1’, cpu: ‘12%’})

In some embodiments, the formatting procedure 111 and the graphical procedure 113 may be integrated into a single procedure. In some embodiments, the format 1331 of the graph database 131 may include a node category, an edge category, a node attribute and an edge attribute. In some embodiments, the storage 13 may comprise a schema database 135 configured to store the format of the graph database 133. In some embodiments, the graphic database 135 may be disposed in the graph database 133.

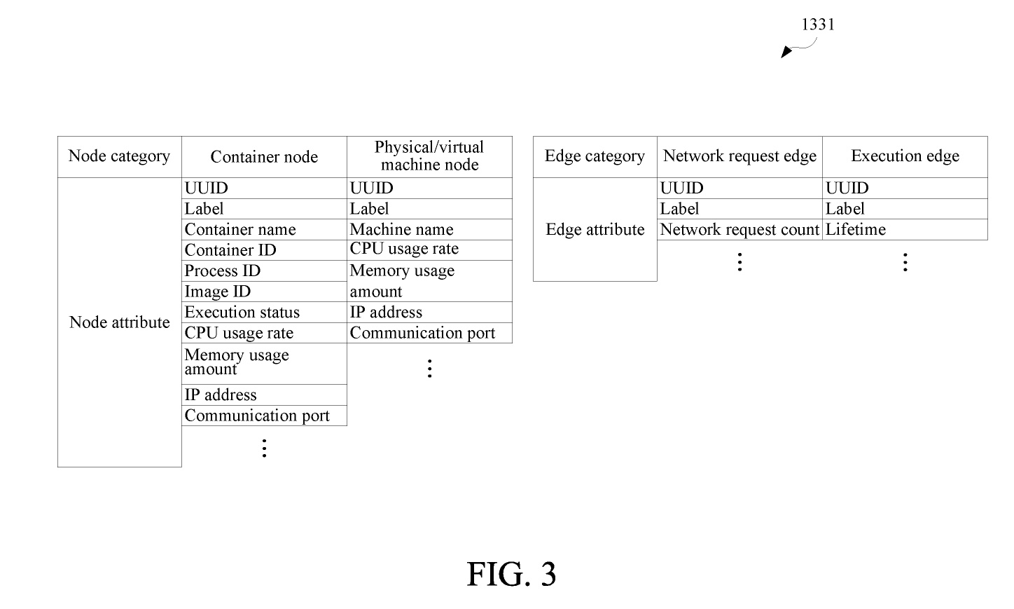

FIG. 3 illustrates a format of a graph database according to one or more embodiments of the present invention. However, the format illustrated in FIG. 3 is provided only as an exemplary example but not to limit the present invention. Referring to FIG. 3, the format 1331 corresponding to the graph database 131 may include a node category, an edge category, a node attribute and an edge attribute; and the node category may include a container node and at least one of a physical machine node and a virtual machine node, and the edge category may include a network request edge and an execution edge.

The node attribute and the edge attribute may be set depending on different needs and the category of the graph database 131. For example, the attribute category of the container node may include but is not limited to: a universally unique identifier (UUID) generated by the graph database, a label, a container name, a container ID, a process ID, an image ID, an execution status of the container, a CPU usage rate, a memory usage amount, an IP address, a communication port, etc. For example, the attribute category of the physical machine node and the virtual machine node may include but is not limited to: a UUID generated by the graph database, a label, a CPU usage rate, a memory usage amount, an IP address, a communication port, etc. In the container data 40, parameters corresponding to the machine name, the CPU usage rate, the memory usage amount, the IP address, and the communication port are just ID information of the physical machine or the virtual machine. For example, the attribute category of the network request edge may include: a UUID generated by the graph database, a label, a network request count, etc. For example, the attribute category of the execution boundary may include: a UUID generated by the graph database, a label, a period of validity, etc. The label may be used to label the categories of the node and the edge.

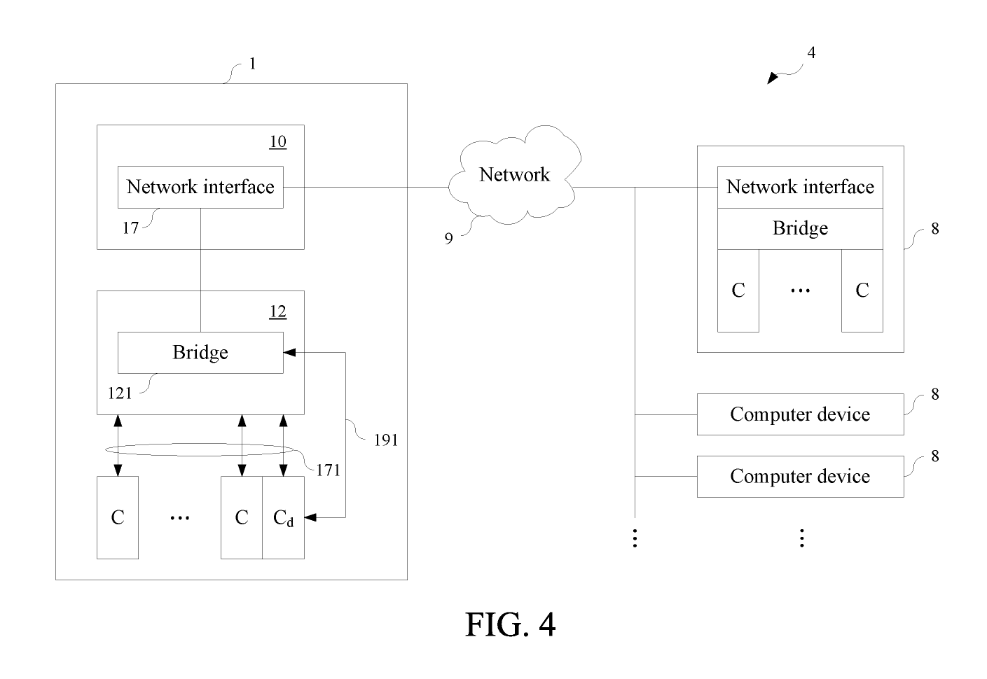

FIG. 4 illustrates a container environment according to one or more embodiments of the present invention. However, the container environment illustrated in FIG. 4 is only provided as an exemplary example but not to limit the present invention. Referring to FIG. 4, in the container environment 4, each container C (e.g., the container C created by the Docker engine) created on an operation system kernel layer 12 of the computer device 1 may be connected to the operation system kernel layer 12 via a container specific application interface (API) 171. The operation system kernel layer 12 may comprise a bridge 121 (e.g., Docker0 preset in the Docker system) configured to connect each container C to a physical network interface card comprised in the network interface 17 of the hardware layer 10. Each container C in the computer device 1 can communicate with and exchange data with any other computer device 8 and the virtual machine and/or container C comprised therein on the network 9 via the bridge 121 and the network interface 17.

In some embodiments, the processor 11 may create at least one detection container C_{d} on the operation system kernel layer 12 of the computer device 1 in the container environment 4. The at least one detection container C_{d} may be used for detection in the container environment 4 to provide the container data 40 to the processor 11. For example, the at least one detection container C_{d} may detect identification data comprised in the container data 40 from the operation system kernel layer 12 through the container API 171. The identification data may comprise identification data of the computer device 1 and each computer device 8 (i.e., identification data of the physical machines), identification data of containers C comprised in the computer devices and identification data of virtual machines comprised in the computer devices.

In some embodiments, the at least one detection container C_{d} may detect dependency data of the container data 40 via a traffic detection interface 191. For example, the traffic detection interface 191 may adopt a software kit Packetbeat that supports such protocols as ICMP, DNS, HTTP, AMQP, Cassandra, Mysql, PSQL, Redis, Thrift-RPC, MongoDB, Memcache, etc. Because containers comprised in each computer device connect with each other and connect to the network 9 via the bridge inside the computer device, dependency status between each container C and other containers C, between the container C and other physical machines, and between the container C and other virtual machines can be known by the processor 11 through simply using the software kit Packetbeat to detect a source and a destination of each packet passing through the bridge 121 so as to obtain the dependency data comprised in the container data 40.

In some embodiments, the processor 11 may determine whether to transform the container data 40 into the graph data 50 (i.e., whether to synchronize the container data 40 to the graph data 50 in the graph database 133) according to the detection result of the detection container C_{d}. In detail, the processor 11 can determine whether there is any variation of the container, the physical machines and the virtual machines (e.g., added, deleted, immigrated, updated and etc.) according to the identification data and the dependency data detected by the at least one detection container C_{d}, and then determine whether to transform the container data 40 into the graph data 50 according to the variation.

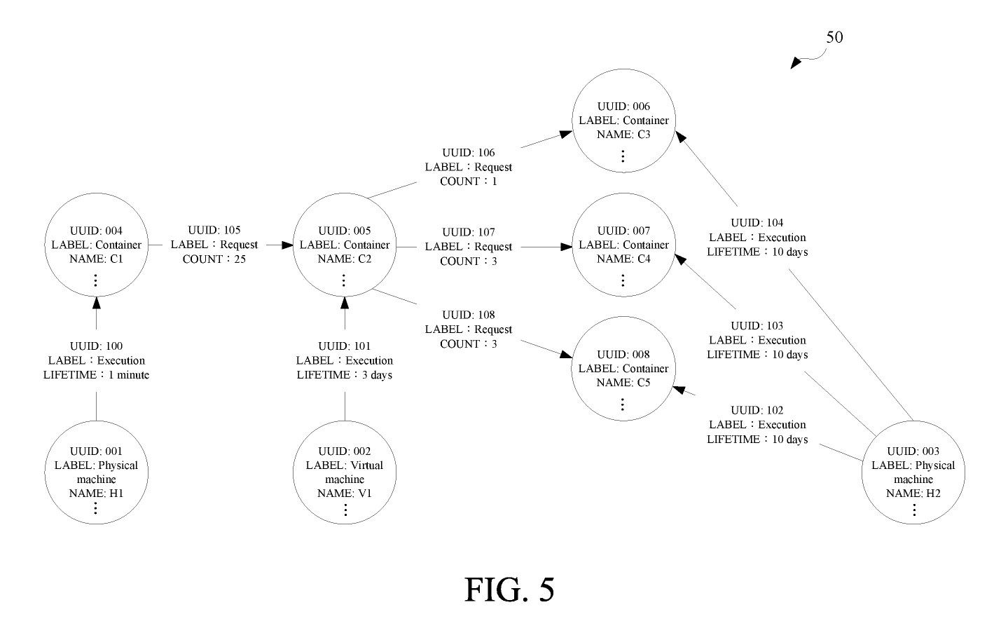

FIG. 5 illustrates graph data in a graph database according to one or more embodiments of the present invention. However, the graph data illustrated in FIG. 5 is provided only as an exemplary example but not to limit the present invention. Referring to FIG. 5, assume that the graph database 133 is a graph database named neo4j, and the graph data 50 comprises two physical machine nodes (of which the UUIDs are 001 and 003 respectively, and the machine names are H1 and H2 respectively), one virtual machine node (of which the UUID is 002, and the machine name is V1), five container nodes (of which the UUIDs are 004˜008 respectively, and the container names are C1˜C5 respectively), five execution edges (of which the UUIDs are 100˜104 respectively) and four network request edges (of which the UUIDs are 105˜108 respectively). The physical machine node having the UUID of 001 executes the container node having the UUID of 004 for 1 minute, the virtual machine node having the UUID of 002 executes the container node having the UUID of 005 for 3 minutes, and the physical machine node having the UUID of 003 executes the container nodes having the UUIDs of 006˜008 for ten days. The container node having the UUID of 004 requests the container node having the UUID of 005 for twenty-five times, the container node having the UUID of 005 requests the container node having the UUID of 006 for twenty-five times, and the container node having the UUID of 005 requests the container nodes having the UUIDs of 007 and 008 thrice.

By using a graph manipulation language (e.g., Cypher) corresponding to the graph database 133 (e.g., neo4j), the user may instruct the processor 11 to enquire the graph data 50 illustrated in FIG. 5 so as to obtain various kinds of information necessary for managing the containers. For example, the user may instruct to enquire the graph data 50 according to the following instructions and request that the physical machine node named H1 and all container nodes executed by this physical machine node be reported:
MATCH (host)-[r:run]-(containers)
WHERE host name=“H1”
RETURN host, containers
   Then, the physical machine node having the UUID of 001, the container node having the UUID of 004 and the execution edge having the UUID of 100 are presented by the graph database 133 in the form of a graph.

As another example, the user may instruct to enquire the graph data 50 according to the following instructions and request that the container node named C1 and all container nodes requested by this container node C be reported so as to obtain relations between the container node named C1 and all container nodes requested by this container node C:
MATCH (container)-[r:request*]-(containers)
WHERE container.name=“C1”
RETURN container, containers

Then, the container node having the UUIDs of 004˜008, and the network request edges having the UUIDs of 105˜108 are presented by the graph database 133 in the form of a graph.

As still another example, the user may instruct to enquire the graph data 50 according to the following instructions and request that the container node named C1, all container nodes requested by this container node C, and the total times of request be reported so as to obtain a network request cost of the container node named C1:
MATCH (container)-[r:request*]-(containers)
WHERE container.name=“C1”
With sum (r.count) AS total_request
RETURN container, containers, total_request

Then, the container node having the UUIDs of 004˜008, the network request edges having the UUIDs of 105˜108, and total_request=32 (i.e., the total times of request) are presented by the graph database 133 in the form of a graph.

In some embodiments, the user may instruct the processor 11 to enquire the network request edge and the execution boundary by using a graph manipulation language (e.g., Cypher) corresponding to the graph database 133 (e.g., neo4j) so as to obtain the traffic input into the container and the traffic output from the container. In some embodiments, the user may also instruct the processor 11 to enquire an overall CPU usage rate, an overall memory usage amount and the total network request count of a group of dependent nodes by using a graph manipulation language (e.g., Cypher) corresponding to the graph database 133 (e.g., neo4j) so as to determine a necessary path in this group of dependent nodes. In some embodiments, the user may also instruct the processor 11 to enquire the resource utilization rate of the node(s) by using a graph manipulation language (e.g., Cypher) corresponding to the graph database 133 (e.g., neo4j) so as to balance the containers disposed on the physical machine(s) or the virtual machine(s). Further, the user may also instruct the processor 11 to make various enquiries by using a graph manipulation language (e.g., Cypher) corresponding to the graph database 133 (e.g., neo4j) so as to obtain various kinds of information necessary for managing the container(s) as long as this does not depart from the spirit of the present invention.

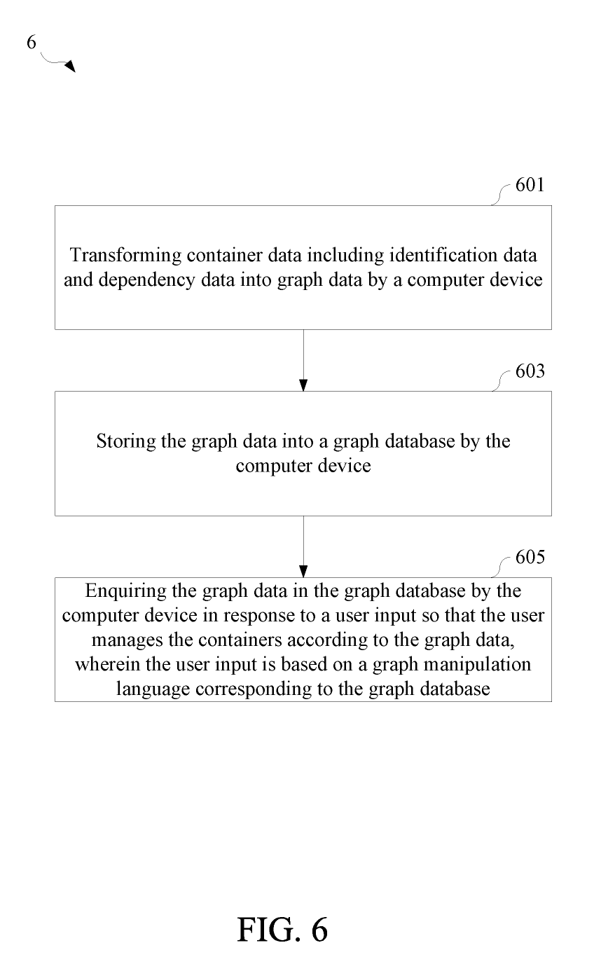

FIG. 6 illustrates a method for facilitating a user to manage containers according to one or more embodiments of the present invention. However, the method illustrated in FIG. 6 is provided only as an exemplary example but not to limit the present invention. Referring to FIG. 6, the method 6 for facilitating a user to manage containers may comprise the following steps: transforming container data including identification data and dependency data into graph data by a computer device (labeled as 601); storing the graph data into a graph database by the computer device (labeled as 603); and enquiring the graph data in the graph database by the computer device in response to a user input so that the user manages the containers according to the graph data, wherein the user input is based on a graph manipulation language corresponding to the graph database (labeled as 605). The sequence of steps 601˜605 presented in FIG. 6 is not intended to limit the present invention, but may be adjusted within the spirits of the present invention.

In some embodiments, the step 601 may comprise the following steps of: executing a formatting procedure by the computer device to format the container data into a format corresponding to the graph database; and executing a graphical procedure by the computer device to transform the formatted container data into the graph data.

In some embodiments, the step 601 may comprise the following steps of: executing a formatting procedure by the computer device to format the container data into a format corresponding to the graph database; and executing a graphical procedure by the computer device to transform the formatted container data into the graph data. Further, the format corresponding to the graph database may include a node category, an edge category, a node attribute and an edge attribute.

In some embodiments, the step 601 may comprise the following steps of: executing a formatting procedure by the computer device to format the container data into a format corresponding to the graph database; and executing a graphical procedure by the computer device to transform the formatted container data into the graph data. Further, the format corresponding to the graph database may include a node category, an edge category, a node attribute and an edge attribute. The node category may include a container node and at least one of a physical machine node and a virtual machine node, and the edge category may include a network request edge and an execution edge.

In some embodiments, the method 6 may further comprise the following step of: creating at least one detection container in a container environment by the computer device, wherein the at least one detection container is configured for detection in the container environment to provide the container data to the processor.

In some embodiments, the method 6 may further comprise the following step of: creating at least one detection container in a container environment by the computer device, wherein the at least one detection container is configured for detection in the container environment to provide the container data to the processor. Further, the at least one detection container may use a container specific application interface to detect the identification data.

In some embodiments, the method 6 may further comprise the following step of: creating at least one detection container in a container environment by the computer device, wherein the at least one detection container is configured for detection in the container environment to provide the container data to the processor. Further, the at least one detection container may use a traffic detection interface to detect the dependency data.

In some embodiments, the method 6 may further comprise the following step of: creating at least one detection container in a container environment by the computer device, wherein the at least one detection container is configured for detection in the container environment to provide the container data to the processor. Further, the step 601 may further comprise the following step of: determining by the computer device whether to transform the container data into the graph data according to the detection.

In some embodiments, the method 6 may be applied to the computer device 1 to accomplish all operations of the computer device 1. How the method 6 accomplishes steps corresponding to these operations will be readily known by those of ordinary skill in the art from the above description of the computer device 1, so this will not be detailed herein.

According to the above descriptions, the present invention can transform container data into graph data and store the graph data into a graph database to allow the user to manage the container according to the graph data stored in the graph database. As compared with representations (e.g., texts or tables) of the container data itself that cannot present various dependency status of containers easily, the graph data allows for presenting various dependency status of containers easily and visually through a graph traversal operation. Additionally, transforming the container data into the graph data allows the user to easily enquire the graph data by simply using a graph manipulation language corresponding to the graph database. As can be seen, the present invention surely provides a scheme for managing containers easily under the tendency of a fast increasing number of containers.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer device for facilitating a user to manage containers, comprising:
a processor, being configured to transform container data including identification data and dependency data into graph data; and
a storage, comprising a graph database configured to store the graph data;
wherein the processor is further configured to enquire the graph data in the graph database in response to a user input so that the user manages the containers according to the graph data; and
wherein the user input is based on a graph manipulation language corresponding to the graph database.

2. The computer device according to claim 1, wherein the processor executes a formatting procedure to format the container data into a format corresponding to the graph database, and executes a graphical procedure to transform the formatted container data into the graph data.

3. The computer device according to claim 2, wherein the format corresponding to the graph database comprises a node category, an edge category, a node attribute and an edge attribute.

4. The computer device according to claim 3, wherein the node category comprises a container node and at least one of a physical machine node and a virtual machine node, and the edge category comprises a network request edge and an execution edge.

5. The computer device according to claim 1, wherein the processor further creates at least one detection container in a container environment, and the at least one detection container is configured for detection in the container environment to provide the container data to the processor.

6. The computer device according to claim 5, wherein the at least one detection container uses a container specific application interface to detect the identification data.

7. The computer device according to claim 5, wherein the at least one detection container uses a traffic detection interface to detect the dependency data.

8. The computer device according to claim 5, wherein the processor is further configured to determine whether to transform the container data into the graph data according to the detection.

9. A method for facilitating a user to manage containers, comprising:
transforming container data including identification data and dependency data into graph data by a computer device;
storing the graph data into a graph database by the computer device; and
enquiring the graph data in the graph database by the computer device in response to a user input so that the user manages the containers according to the graph data, wherein the user input is based on a graph manipulation language corresponding to the graph database.

10. The method according to claim 9, wherein the step of transforming the container data into the graph data further comprises the following steps of:
executing a formatting procedure by the computer device to format the container data into a format corresponding to the graph database; and
executing a graphical procedure by the computer device to transform the formatted container data into the graph data.

11. The method according to claim 10, wherein the format corresponding to the graph database comprises a node category, an edge category, a node attribute and an edge attribute.

12. The method according to claim 11, wherein the node category comprises a container node and at least one of a physical machine node and a virtual machine node, and the edge category comprises a network request edge and an execution edge.

13. The method according to claim 9, further comprising the following step of:
creating at least one detection container in a container environment by the computer device, wherein the at least one detection container is configured for detection in the container environment to provide the container data to the processor.

14. The method according to claim 13, wherein the at least one detection container uses a container specific application interface to detect the identification data.

15. The method according to claim 13, wherein the at least one detection container uses a traffic detection interface to detect the dependency data.

16. The method according to claim 13, wherein the step of transforming the container data into the graph data further comprises the following step of:
determining by the computer device whether to transform the container data into the graph data according to the detection.
